(19) United States
(12) Patent Application Publication
(10) Pub. No.: US 2004/0262892 A1
(43) Pub. Date: Dec. 30, 2004

(54) Airbag module and cover

(75) Inventor: Naoki Soejima, Kanzaki-gun (JP)

Correspondence Address: FOLEY AND LARDNER, SUITE 500, 3000 K STREET NW, WASHINGTON, DC, 20007, US

(73) Assignee: TAKATA CORPORATION

(21) Appl. No.: 10/824,373

(22) Filed: Apr. 15, 2004

(30) Foreign Application Priority Data
Jun. 30, 2003 (JP) 2003-187626

(51) Int. Cl. B60R 21/20; B60R 21/16

(52) U.S. Cl. 280/728.3

(57) ABSTRACT

An airbag cover and method constructing a cover for covering a vehicle airbag. The method includes forming a linear groove with a predetermined depth within the thickness of the airbag cover. The groove is formed by ultrasonic waves.

### BACKGROUND

The present invention relates to a cover for a vehicle airbag.

An airbag device which is mounted to a vehicle has a cover for covering an airbag. The airbag cover has a tear line (linear groove) in an inner wall surface thereof, and allows deployment and inflation of the airbag outward from the airbag cover as a result of tearing at the tear line when the vehicle collides. The tear line may be formed by post-processing, using a technique such as, for example, laser cutting. Japanese Patent Publication No. 2001-502996 (incorporated by reference herein), discloses a relevant example of a process for forming a tear line.

However, in forming a tear line using laser cutting, there is a limit as to how much processing costs are reduced due to the use of a laser processing structure. The production of the airbag cover is further complicated because the shape of the cover has become more complicated due to setting the airbag cover at various locations in recent years.

### SUMMARY OF THE INVENTION

The present invention is applicable to various vehicles including automobiles, trains, motorcycles (vehicles that a rider sits astride), airplanes, and ships.

According to an embodiment of the present invention, a method of producing an airbag cover for covering a vehicle airbag is provided. According to the embodiment, a three-dimensionally molded plate-shaped airbag cover is post-processed by ultrasonic processing mechanism in order to form a linear groove in the airbag cover. In other words, using the ultrasonic processing mechanism, a linear groove is formed in a molded airbag cover. The linear groove is a groove which is continuously formed with a predetermined depth within the thickness of the plate-shaped airbag cover. The linear groove is defined by a relatively thin portion of the airbag cover, and is what is called a tear line. The airbag cover is torn at the linear groove when the airbag is deployed and inflated.

An ultrasonic processing mechanism may include various structures and devices which can process an object by transmitting (imparting) ultrasonic waves to the object. A typical example is a structure for processing an object with ultrasonic waves by operating a blade-like member (ultrasonic processing blade) upon the object. Examples of ultrasonic processing mechanism other than a blade-like member include rod-shaped or plate-shaped ultrasonic processing mechanism. A typical example of a processor using the ultrasonic processing mechanism is a structure for controlling the operation of the ultrasonic processing blade to which ultrasonic waves are transmitted by a processing robot. The operation of the ultrasonic processing blade may be controlled so that it is carried out in a predetermined path.

According to the present invention, by using the ultrasonic processing mechanism, it is possible to provide an efficient method of producing an airbag cover having a linear groove formed by post-processing. In other words, the processing speed when, for example, an ultrasonic processing blade is used as ultrasonic processing mechanism is greater than the processing speed when laser is used (for example, approximately 1.5 times greater), so that the technology using the ultrasonic processing mechanism is effective in increasing the efficiency with which the airbag cover is produced. In addition, it is possible to use a general-purpose machine in a facility of, for example, the ultrasonic processing mechanism and a processing robot. Therefore, compared to a laser processing facility having a greater need for using a special-purpose machine, facility costs can be reduced.

Post-processing a three-dimensionally molded plate-shaped airbag cover using an ultrasonic processing mechanism makes it possible to meet the demands arising when the shapes of the airbag cover become complicated because it is set at various locations. As opposed to such a technology of the present invention, there is, for example, another technology in which a linear groove is two-dimensionally formed in an outer portion of the airbag cover in a plane by the ultrasonic processing mechanism, and, then, this outer portion is disposed at a three-dimensionally molded location, so that the airbag cover has a three-dimensional form as a whole. However, when such a technology is used, there is a limit as to how much production costs are reduced because the process of producing the airbag cover becomes complicated. Accordingly, a technology, such as that of the present invention, of directly processing a three-dimensionally molded plate-shaped airbag cover by the ultrasonic processing mechanism is effective in simplifying the production process.

Therefore, according to the present invention, it is possible to reduce the production time as a result of simplifying the production process itself, in addition to reducing the production time by using the ultrasonic processing mechanism having a high processing speed.

According to the present invention, by using the ultrasonic processing mechanism, it is possible to provide a cover including a highly reliable linear groove which makes it possible for the airbag cover to tear when the airbag is deployed and inflated. In the conventional laser cutting process, due to structural reasons, grooves are formed discontinuously in the form of dots. Therefore, the depths of the grooves may be non-uniform. However, in an exemplary embodiment of the present invention, when the ultrasonic processing mechanism is used, the linear groove is continuously formed. The operation of the ultrasonic processing mechanism may be controlled by a processing robot in order to provide a uniform groove depth. A linear groove having uniform depth, as provided according to the present invention, is effective in smoothly tearing the airbag cover when the airbag is deployed and inflated.

According to an exemplary embodiment of the present invention, before forming the linear groove, a first distance between a processing edge of the ultrasonic processing mechanism, such as a cutting edge of an ultrasonic processing blade, and a predetermined location at the ultrasonic processing mechanism is determined. In addition, when the linear groove is to be formed, a second distance between a processing surface of the airbag cover and a predetermined location at the ultrasonic processing mechanism is determined. The first and second distances can be determined using, for example, information detected by a laser displacement meter.

The first and second distances may be determined according to a number of acceptable methods. For example, the data may be directly obtained using a detector. The data may be further processed by, for example, computation techniques. The data may be used to determined the difference between the determined first and second distances. The distance that the ultrasonic processing mechanism has penetrated from the processing surface of the airbag cover in a plate thickness direction during processing, that is, the depth of the linear groove or the residual thickness at the linear groove can be determined. Typically, after determining the depth of the linear groove, the residual thickness at the linear groove is determined from the depth of the linear groove.

According to the present invention, it is possible to indirectly estimate the depth of the linear groove from the first and second distances, so that it can be estimated without directly measuring the depth of the linear groove. When the depth of the linear groove is to be directly measured, it is difficult to precisely measure the depth of the linear groove unless the width of the linear groove (length of the linear groove in a direction perpendicular to the direction of extension of the linear groove) is a certain value. However, if the width of the linear groove is increased, the airbag cover may be less properly torn at the linear groove. Thus, according to the present invention the depth of the groove is preferably indirectly measured from the first and second distances, thereby making it possible to maintain a good tearing ability at the linear groove of the airbag cover.

According to an embodiment of the present invention, the airbag cover has a three-dimensionally molded plate-shaped structure, and has a linear groove which is continuously formed with a predetermined depth within the thickness of the airbag cover. The linear groove is formed by post-processing. Preferably, the linear groove is formed by ultrasonic processing mechanism. The linear groove has a uniform depth so that the linear groove is effective in allowing smooth tearing of the airbag cover when a vehicle airbag is deployed and inflated.

According to another alternative embodiment of the present invention, an airbag module is provided. The airbag module may include, for example, a vehicle airbag, an accommodating member for accommodating the vehicle airbag, gas supplying mechanism for supplying inflation gas to the vehicle airbag, and an airbag cover, such as described above. The airbag module is mounted to a vehicle. The airbag module of the present invention may also include a member to which the airbag cover is disposed such as, for example, an instrument panel.

According to the an embodiment of the present invention, it is possible to provide an efficient technology of constructing an airbag module which is effective in allowing smooth tearing of the airbag cover when the vehicle airbag is deployed and inflated.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a perspective view of an airbag cover and an ultrasonic processor according to an embodiment of the present invention.

FIG. 2 is a flowchart disclosing the steps of processing the airbag cover using the ultrasonic processor.

FIG. 3 is a schematic view illustrating Steps S20 to S30 in FIG. 2.

FIG. 4 is a schematic view illustrating Step S24 in FIG. 2.

FIG. 5 is a schematic view illustrating Step S28 in FIG. 2.

FIG. 6 is a schematic view illustrating Step S28 in FIG. 2.

FIG. 7 is a sectional view of a tear line formed in the airbag cover by carrying out the ultrasonic processing process illustrated in FIG. 2.

FIG. 8 is a sectional view taken in a direction of extension of the tear line shown in FIG. 7.

FIG. 9 is a sectional view of a form of a tear line formed by laser processing.

FIG. 10 is a sectional view of the structure of an airbag module with the cover shown in the closed and torn open conditions.

### DETAILED DESCRIPTION

Hereunder, a description of embodiments of the present invention will be given with reference to the drawings. The present invention relates to forming a tear line 102 by ultrasonic processing in a back surface 101 of an airbag cover 100 for covering a vehicle airbag.

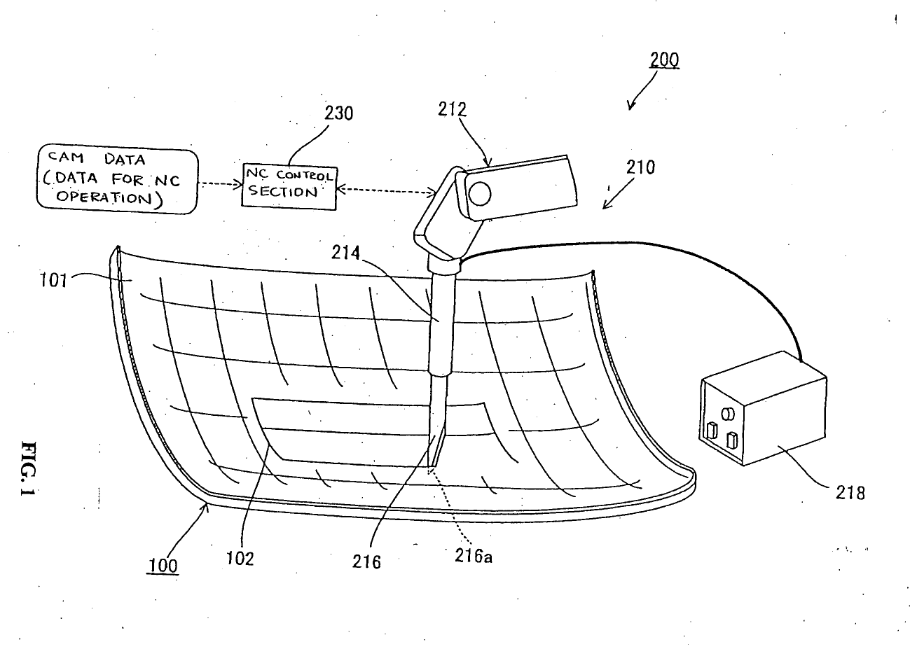

The structures of the airbag cover 100 and an ultrasonic processor 200 will first be described with reference to FIG. 1. FIG. 1 shows the structures of the airbag cover 100 and the ultrasonic processor 200 for processing the airbag cover 100.

The airbag cover 100 shown in FIG. 1 is a plate-shaped cover which has been three-dimensionally molded out of resin material such as, for example, a polypropylene (PP) material or an olefin elastomer (TPO) material. The back surface 101 of the airbag cover 100 is defined as such when the surface of the airbag cover 100 that opposes a rider is defined as the front surface. The tear line 102 is defined by a thin portion of the airbag cover 100 in order to allow tearing of the airbag cover 100 when the airbag is deployed and inflated, and is, in the embodiment, a linear groove formed in the back surface 101 of the airbag cover 100. The tear line 102 corresponds to a linear groove.

As shown in FIG. 1, the ultrasonic processor 200 roughly comprises a drive section 210 and an NC control section 230. The drive section 210 comprises, for example, a drive arm 212, an ultrasonic oscillation portion 214, an ultrasonic processing mechanism (preferably a blade) 216, and an ultrasonic wave oscillator 218.

The drive arm 212 forms a portion of a processing robot, and is controlled based on an input signal from the NC control section 230 in order to adjust the position of a processing edge 216a of the ultrasonic processing blade 216. The ultrasonic oscillation portion 214 transmits ultrasonic waves oscillated by the ultrasonic wave oscillator 218 to the ultrasonic processing mechanism 216. The processing or cutting edge 216a of the ultrasonic processing blade 216 may have a width of, for example, 1 mm. As long as a member can process an object by transmitting (imparting) ultrasonic waves to the object, for example, a rod-shaped or a plate-shaped member may be used as an alternative to the blade-like member such as the ultrasonic processing blade 216 in the embodiment. As the ultrasonic wave oscillator 218, an ultrasonic wave oscillator which can oscillate ultrasonic waves having a frequency of, for example, 22 kHz is used. The ultrasonic processor 200 in the embodiment also comprises displacement meters 221 and 222, and an image testing camera 223, which are described later.

The NC control section 230 is used for processing data for forming the tear line 102 in the back surface 101 of the airbag cover 100. The NC control section 230, for example, inputs, computes, and outputs data for processing the airbag cover 100.

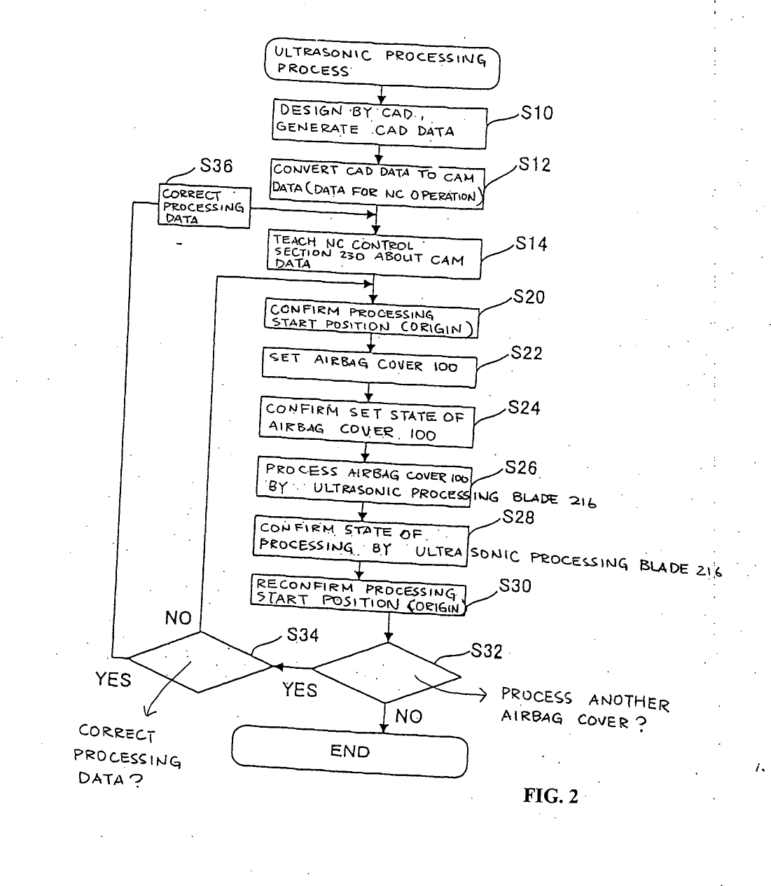

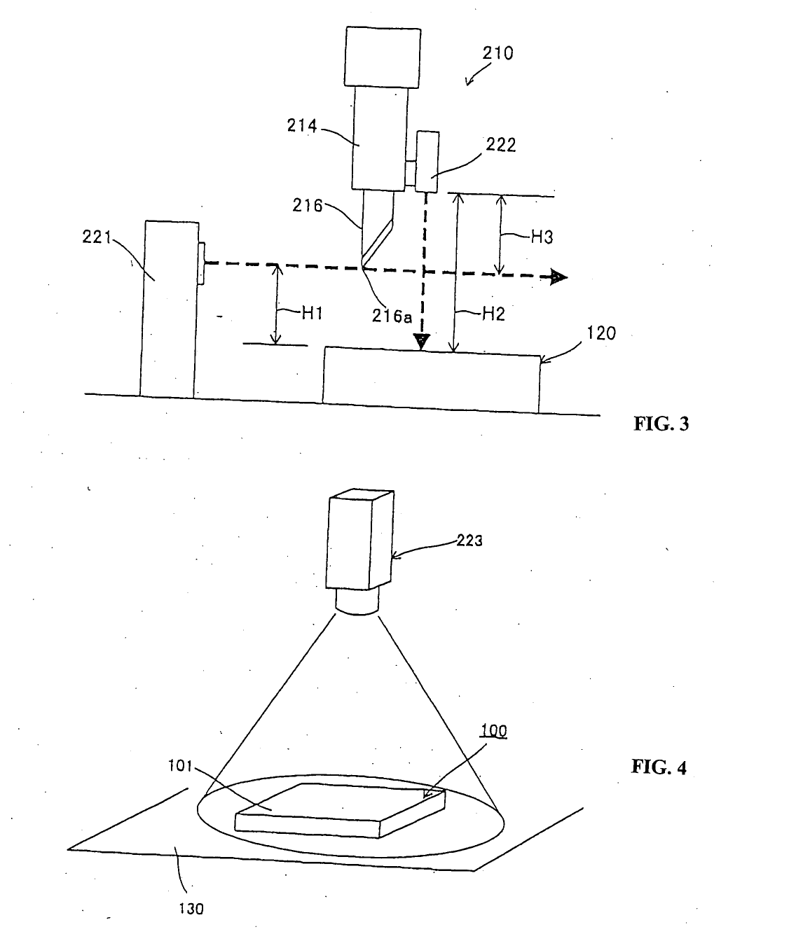

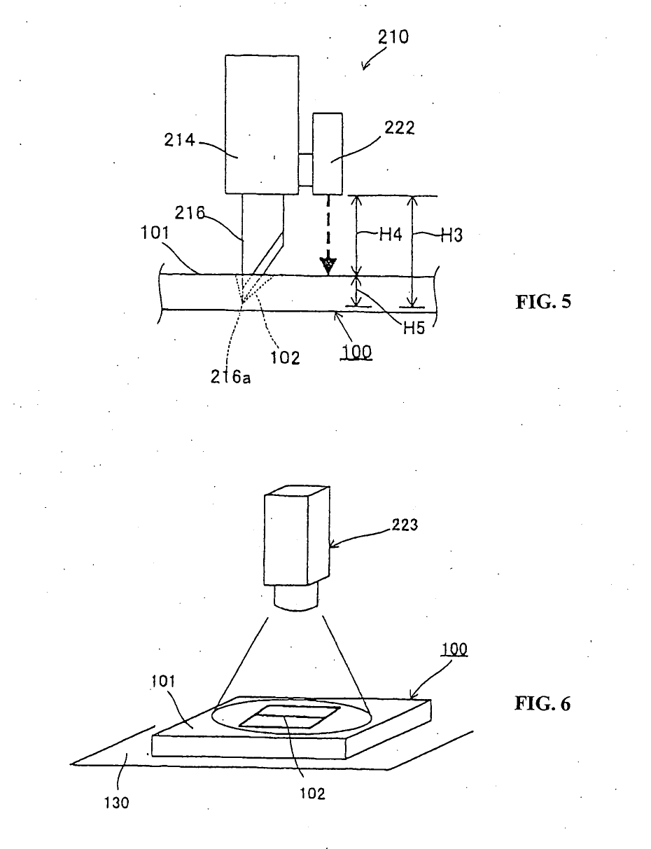

Next, the steps of forming the tear line 102 by post-processing the molded airbag cover 100 using the ultrasonic processor 200 having the above-described structure will be described with reference to FIGS. 2 to 6. FIG. 2 is a flowchart of the steps of processing the airbag cover 100 with ultrasonic waves using the ultrasonic processor 200. FIG. 3 is a schematic view illustrating Steps S20 to S30 in FIG. 2. FIG. 4 is a schematic view illustrating Step S24 in FIG. 2. FIGS. 5 and 6 are schematic views illustrating Step S28 in FIG. 2.

The processing process in the embodiment is roughly divided into a data processing process of processing processing data before processing the airbag cover 100 and an actual processing process of actually processing the airbag cover 100 by the ultrasonic processor.

In the data processing process, processing data is obtained before actually processing the airbag cover 100. The data processing process comprises Steps S10 to S14 as shown in FIG. 2.

First, in Step S10, designing is performed by computer-aided design (CAD) based on design information of the airbag cover 100 in order to generate CAD data (processing data). Here, for example, design information that is previously stored in a computer is output on a graphic display device to carry out the designing while watching the screen of the graphic display device.

In Step S12, the CAD data obtained in Step S10 is converted by computer-aided manufacturing (CAM) in order to generate CAM data. The CAM data is processing data (data for NC operation) at the NC control section 230.

In Step S14, the CAM data (processing data) obtained in Step S12 is input to the NC control section 230 in order to carry out CAM data teaching. In the embodiment, the CAM data that is input to the NC control section 230 once can be corrected at the NC control section 230 based on actual processing results.

When the data processing process is completed, the airbag cover 100 is actually processed. The actual processing process comprises Steps S20 to S30 as shown in, for example, FIG. 2.

First, in Step S20, prior to processing the airbag cover 100, a processing start position (origin) of the ultrasonic processing blade 216 is confirmed. The confirmation is carried out using, for example, the displacement meters 221 and 222 of laser types. The displacement meter 221 is disposed at a base, and the displacement meter 222 is disposed at the ultrasonic processing blade 216 of the drive section 210. In such a structure, as shown in FIG. 3, the displacement meter 221 detects a height H1 (distance) from the top surface of a reference block 120 to the cutting blade 216a of the ultrasonic processing blade 216. The displacement meter 222 detects a height H2 (distance) from the top surface of the reference block 120 to the displacement meter 222.

Then, by calculating the difference between the detected heights H1 and H2 (H2−H1), a height H3 from the displacement meter 222 to the cutting edge 216a of the ultrasonic processing blade 216 is obtained (determined). As a result, the processing start position (origin) of the ultrasonic processing blade 216 is determined.

The number of detection points for detecting the height H1 with the displacement meter 221 and that for detecting the height H2 by the displacement meter 222 in Step S20 may be set as required considering, for example, the shape of the airbag cover 100. For example, it is desirable that the more complicated the shape of the airbag cover 100 is, a larger number of detection points for detecting the heights H1 and H2 be used.

Next, in Step S22, the airbag cover 100 is set on a receiver jig (receiver jig 130 in FIG. 4). Then, in Step S24, the set state of the airbag cover 100 is confirmed.

Although not particularly illustrated, the receiver jig 130 has an attracting mechanism using air (e.g., a vacuum). By operating the attracting mechanism, the airbag cover 100 can be attracted to and held by the receiver jig 130. The attracting mechanism has a structure which allows detection of attraction pressure. In such a structure, the state of contact between the airbag cover 100 and the receiver jig 130 is confirmed by the attraction pressure of the attracting mechanism, and, as shown in FIG. 4, any shifts in the position of the airbag cover 100 is confirmed by the image testing camera 223. By this, a worker can confirm the set state of the airbag cover 100.

In Step S26, the actual processing of the airbag cover 100 by the ultrasonic processing blade 216 is started. Here, the ultrasonic wave oscillator 218 oscillates ultrasonic waves having a frequency of, for example, 22 kHz, and transmits them to the ultrasonic processing blade 216 through the ultrasonic oscillation portion 214. Based on an input signal from the NC control section 230, the drive arm 212 is controlled in order to adjust the position of the cutting edge 216a of the ultrasonic processing blade 216. By this, the processing operation of the ultrasonic processing blade 216 is controlled so that it is carried in a predetermined path. The processing speed of the ultrasonic processing blade 216 may be, for example, 30 mm/sec. This processing speed is 1.5 times greater than a laser processing speed of 20 mm/sec, so that this method is effective in increasing the efficiency with which the airbag cover 100 is produced.

Processing conditions, such as the frequency of the ultrasonic waves oscillated from the ultrasonic oscillator 218 and the processing speed of the ultrasonic processing blade 216, can be set as required based on conditions of the object to be processed, such as the material or thickness of the airbag cover.

In Step S28, the state of processing by the ultrasonic processing blade 216 when the ultrasonic processing blade 216 is processing the airbag cover 100 in Step S26 is confirmed. Here, as shown in FIG. 5, the displacement meter 222 detects a height H4 (distance) from the back surface 101 of the airbag cover 100 to the displacement meter 222.

By calculating the difference (H3−H4) between the height H3 (from the displacement meter 222 to the cutting edge 216a of the ultrasonic processing blade 216) previously detected in Step S20 and the height H4, a processing depth (i.e., cut depth) H5 of the tear line 102 can be determined. Accordingly, in the embodiment of the present invention, the processing depth H5 of the tear line 102 is indirectly estimated based on other detection information, so that the processing depth H5 of the tear line 102 can be estimated without directly detecting it. Based on the processing depth H5 and control data of the NC control section 230, it is possible to confirm the residual thickness at the location of the tear line 102 of the airbag cover 100. In this way, the airbag cover 100 with the tear line 102 having a predetermined depth is produced.

In Step S28, the number of detection points for detecting the height H4 by the displacement meter 222 may be set as required considering, for example, the shape of the airbag cover 100. For example, it is desirable that the more complicated the shape of the airbag cover 100 is, a larger number of detection points for detecting the height H4 be used. As shown in FIG. 6, the processing path of the tear line 102 may be confirmed by the image testing camera 223.

In Step S30, the processing start position (origin) of the ultrasonic processing blade 216 is reconfirmed by carrying out the operations that are similar to those in Step S20.

After Step S30 is completed, a determination is made in Step S32 as to whether or not to process another airbag cover. If it is determined that another airbag cover is not to be processed in Step S32, the processing ends. In contrast, if it is determined that another airbag cover is to be processed in Step S32, a determination is made in Step S34 as to whether or not processing data is to be corrected from the time of processing. If it is determined that the processing data is to be corrected in Step S34, the processing data is corrected in Step S36, after which the process returns to Step S14. In contrast, if it is determined that the processing data is not to be corrected in Step S34, the process returns to Step S20.

As described above, in the embodiment, since the ultrasonic processing blade 216 is used, the airbag cover 100 can be processed at a speed that is, for example, 1.5 times greater than the laser processing speed, so that this method is effective in increasing the efficiency with which the airbag cover 100 is produced. In addition, it is possible to use a general-purpose machine in a facility of, for example, the ultrasonic processing blade 216 and a processing robot. Therefore, compared to a laser processing facility having a greater need for a special-purpose machine, facility costs can be reduced.

As opposed to the embodiment, there is, for example, another technology in which a linear groove is two-dimensionally formed in an outer portion of an airbag cover in a plane by an ultrasonic processing blade, and, then, this outer portion is disposed at a three-dimensionally molded location, so that the airbag cover has a three-dimensional form as a whole. However, when such a technology is used, there is a limit as to how much production costs are reduced because the process of producing the airbag cover becomes complicated. Accordingly, a technology, such as that of the present invention, of directly processing a three-dimensionally molded plate-shaped airbag cover by the ultrasonic processing blade is effective in simplifying the production process. Therefore, according to the present invention, it is possible to reduce the production time as a result of simplifying the production process itself, in addition to reducing the production time by using the ultrasonic processing blade having a high processing speed.

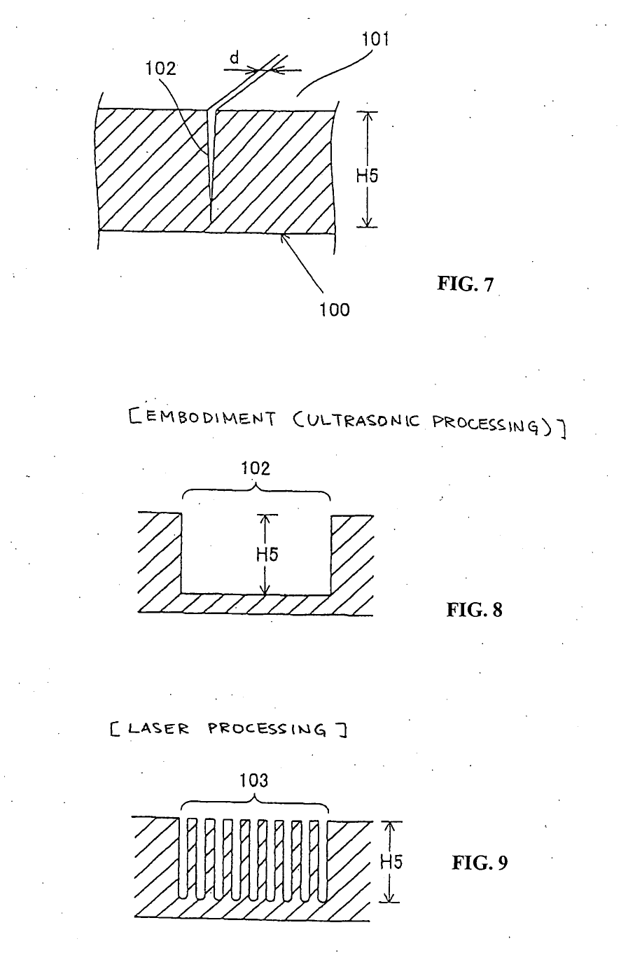

According to an embodiment of the present invention, using the ultrasonic processing blade 216, the tear line 102 can be continuously formed, so that the groove can have a uniform depth. Therefore, compared to the case in which grooves are formed in the form of dots by laser processing, the linear groove is effective in allowing smooth tearing of the airbag cover 100 when an airbag is deployed and inflated. In other words, in the embodiment, by processing the airbag cover 100 by the ultrasonic processing blade 216 in Step S26, for example, the tear line 102 (having the depth H5 and a width d in the back surface 101) that is defined by sharp portions in cross section as shown in FIGS. 7 and 8 can be formed. In contrast, when laser processing is carried out, for example, a tear line 103 comprising grooves that are discontinuously formed in the form of dots as shown in FIG. 9 is formed. Even if the distances between the dot-shaped grooves are decreased in the tear line 103 shown in FIG. 9, there is a limit as to how close the tearing ability at the tear line 103 can be compared to the tearing ability at the tear line 102 in the embodiment.

When the depth of the tear line 102 is to be directly measured, the depth of the tear line 102 which is defined by the sharp portions in cross section in the embodiment may not be precisely measured. However, since, according to the present invention, the depth of the tear line 102 is indirectly measured, the tear line 102 can be defined by the sharp portions in cross section. The tear line 102 defined by the sharp portions in cross section is effective in maintaining a good tearing ability during the deployment and inflation of the airbag.

When the three-dimensional form of the airbag cover, which is an object to be processed, is complicated, it is sometimes difficult to directly detect the processing depth H5 of the tear line 102. However, according to the present invention, information regarding the processing depth H5 of the tear line 102 is constantly detected during the processing to determine a highly reliably processing depth H5. As a result, the present invention is particularly effective in reliably forming the tear line 102 with a predetermined depth in the three-dimensionally molded airbag cover.

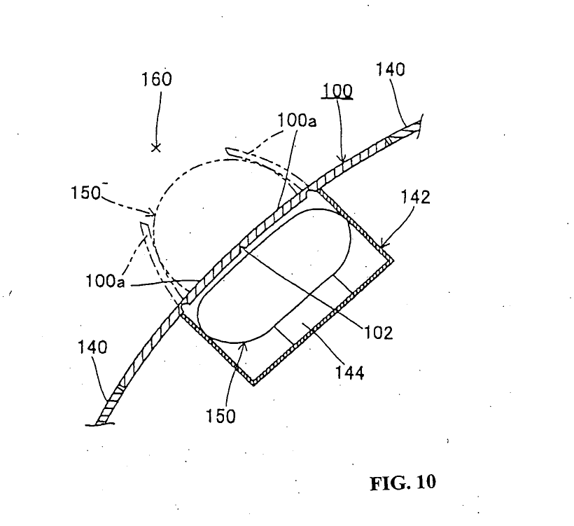

The airbag cover 100 produced by the above-described method may be incorporated in a vehicle, for example, as shown in FIG. 10. In other words, parts such as the airbag cover 100, an instrument panel 140 at which the airbag cover 100 is disposed, a vehicle airbag 150, an accommodating member (retainer) 142 in which the vehicle airbag 150 is accommodated in a folded state, and gas supplying mechanism (inflator) 144, disposed in the accommodating member 142, for supplying inflation gas to the vehicle airbag 150 may form an airbag module.

When a vehicle collides at a location which is situated in front of the vehicle, the gas supplying mechanism 144 operates to deploy the vehicle airbag 150 by inflation gas supplied from the gas supplying mechanism 144. The airbag cover 100 is torn at the tear line 102 during the deployment and inflation of the vehicle airbag 150, so that, for example, a pair of deployment doors 100a are both opened towards the front surface of the airbag cover 100. In this way, the vehicle airbag 150 is deployed outward from the airbag cover 100 through the deployment doors 100a that are opened, so that it is further deployed and inflated while protruding towards a rider protection area 160 that is situated in front of a rider.

The present invention provides an efficient technology of constructing an airbag cover for covering a vehicle airbag, and related technologies thereof.

Japan Patent Application No. 2003-187626, filed Jun. 30, 2003, is incorporated herein by reference in its entirety.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. A method of producing a cover for covering a vehicle airbag, the method comprising the steps of:
providing a three-dimensionally molded airbag cover;
forming a tear line with a predetermined depth within the thickness of the airbag cover by ultrasonic processing.

2. The method of claim 1, further comprising the steps of:
determining a first distance between a processing edge of an ultrasonic processing mechanism and a predetermined location on the ultrasonic processing mechanism, and
determining a second distance between a processing surface of the airbag cover and the predetermined location on the ultrasonic processing mechanism.

3. The method of claim 2, further comprising the step of estimating the depth of the tear line based on the determined first and second distances.

4. The method of claim 2, further comprising the step of estimating the residual thickness of the cover at the tear line based on the determined first and second distances.

5. The method of claims 2, wherein the first distance is calculated between the edge of a blade and the predetermined location.

6. A cover for a vehicle airbag comprising:
a three-dimensionally molded plate;
a continuous linear groove with a predetermined depth located in the plate;
wherein the groove is formed by ultrasonic waves.

7. An airbag module comprising:
an airbag;
a cover for covering the vehicle airbag;
an accommodating member for accommodating the vehicle airbag; and
a gas supplying mechanism for supplying inflation gas so that the vehicle airbag is deployed and inflated from the accommodating member,
wherein the cover comprises a three-dimensionally molded plate-shaped structure and has a linear groove which is continuously disposed with a predetermined depth within the thickness of the airbag cover, and
wherein, the module is configured so that when a vehicle collides at a location which is situated in front of the vehicle, the vehicle airbag is deployed by the inflation gas supplied from the gas supplying mechanism, causing the airbag cover to tear at the linear groove, so that the vehicle airbag is further deployed and inflated in a rider protection area which is situated in front of a rider.
